(19) United States
(12) Patent Application Publication
(10) Pub. No.: US 2006/0086282 A1
(43) Pub. Date: Apr. 27, 2006

(54) Phosphate conversion coating and process

(76) Inventors: Jun Qing Zhang, Mason, OH (US); Michael C. Decker, Tipp City, OH (US)

Correspondence Address: WOOD, HERRON & EVANS, LLP, 2700 CAREW TOWER, 441 VINE STREET, CINCINNATI, OH, 45202, US

(21) Appl. No.: 10/984,106

(22) Filed: Nov. 9, 2004

Related U.S. Application Data
(60) Provisional application No. 60/621,886, filed on Oct. 25, 2004.

(51) Int. Cl. C04B 9/02; B05C 5/00

(52) U.S. Cl. 106/14.12; 427/445

(57) ABSTRACT

A manganese modified low zinc phosphate conversion coating is applied to a metal substrate by forming a coating composition having zinc ions, phosphate ions, nickel ions, manganese ions, and, optionally, iron ions, with a free acid range of 0.7 to 1.5 for spray applications, and 3.5 to 5.5 for immersion applications. The nitrate concentration is very low, generally less than 2000 ppm. The coating is applied with generation of minimal sludge, at lower temperatures, generally 120-160° F.

### RELATED APPLICATION

This application is a regular utility application of U.S. Provisional Patent Application Ser. No. 60/621,886, filed on Oct. 25, 2004, the entire disclosure of which is incorporated herein by reference.

### FIELD OF THE INVENTION

The present invention relates to a composition and a method of forming a zinc phosphate conversion coating on a metal surface. More particularly, the present invention relates to a composition and a process for forming a manganese modified zinc phosphate conversion coating on metal surfaces in preparation for painting.

### BACKGROUND OF THE INVENTION

Zinc phosphate conversion coatings are well known. They are used for a variety of different applications. Depending upon the intended use of the substrate, different types of coatings may be applied. If the substrate is intended for further forming or processing, large crystals of the zinc phosphate are desired. If the substrate is intended to be painted, much smaller, finer crystals of the phosphate are preferred.

It has been well known that a zinc phosphate conversion coating, when applied to a metallic surface, such as iron and steel, zinc-coated metal, aluminum, or aluminum-coated metal in metal-coating systems, provides adhesion to paints, lacquers and other such coatings and likewise corrosion resistant properties to such metallic surfaces.

In a metal-coating system or for a painting or coating application, a microcrystalline structure of phosphate coatings is desired. Polymeric coatings will bond and adhere more tenaciously to the microcrystalline coating than to bare metals or coarse crystalline phosphate coatings. It has been found that manganese-modified zinc phosphate compositions deposit coatings far more efficiently when applied to many metallic surfaces, including not only iron and steel, but also zinc-coated metal and aluminum as well. Furthermore, manganese-modified zinc phosphate coatings, specifically low-zinc manganese-modified zinc phosphate coatings, have been found superior for the purposes of paint adhesion, corrosion resistance, and resistance to alkali solubility.

Particularly, nickel contributes to increasing the corrosion resistance of the metal surface after a subsequent polymeric coating is applied, while manganese contributes to increasing the alkali resistance necessary for cathodic electrodeposition of paint. Manganese also functions to improve the water resistance of organic surface coatings over a phosphate film on zinc-coated surfaces (for example, hot-dip galvanized, electroplated galvanized, zinc/nickel-plated, zinc/iron-plated surface, and the like), as well as on the surfaces of articles principally constituted of such metals, for instance, automobile bodies, automobile components, appliances, and building materials.

Along with the development of cathodic electrodeposit coating and its applications in automotive industry since the 1970s, manganese-modified zinc phosphate coatings have almost been the only type of zinc phosphate conversion coating applied in pre-treating automotive bodies, which are typically made of zinc-coated metals. It is extremely important to consistently deposit uniform phosphate coatings on parts to assure consistently uniform deposition of electrodeposited films and satisfactory appearance. Therefore, phosphating systems have become more precise and complex thereby ensuring the higher quality of production. Currently, low-zinc manganese-modified zinc phosphate compositions are working at a low free acid point.

U.S. Pat. No. 6,620,263 discloses a process to form such a paintable phosphate coating. This patent discloses a process that uses a very low free acid value and low free acid to total acid ratio. This is problematic because the metals in the coating composition tend to form a sludge, which creates a waste problem and an environmental hazard. The composition cannot be used at higher free acid and free acid to total acid ratio ranges.

Various attempts have been made in the art to address the above problems. For example, U.S. Pat. No. 4,957,568 to Endres et al. uses complexing agents based on phosphoric acids, and U.S. Pat. No. 6,551,417 to Rodzewich et al. uses disodium glycerolphosphate. However, these efforts have met with limited success and have failed to address other factors such as free acid point and nitrate content.

### SUMMARY OF THE INVENTION

The present invention seeks to solve problems described hereinabove by utilizing a novel, highly efficient composition and process to produce a microcrystalline phosphate conversion coating on various metal surfaces. This invention forms a fine, complete conversion coating on metal surfaces without a high concentration of nitrate additive. This invention is a low-zinc phosphate conversion coating composition, which is applied at higher free acid points and at low temperature operation. Consequently, such operation is more environmentally friendly due to low sludge formation. The coating process of the present invention has several benefits including: 1) applicable to various metal surfaces, 2) less sensitive to various contaminants, and, 3) yields less sludge compared to conventional zinc-nickel phosphatizers.

The present invention is premised on the realization that a coating composition that forms a phosphate coating on metal surfaces suitable for painting can be applied at high free acid levels and high free acid to total acid ratios. More particularly, the composition is a low zinc manganese modified phosphate composition that utilizes as an activator a very small concentration of a nitrite. This forms an effective conversion coating with free acid levels in the range of 0.7-1.5, and preferably from 3.5-5.5 for immersion application, and preferably from 1.0 and 4.5, respectively; with a ratio of total acid to free acid of 28-30 for spray application and 6-7 for immersion application. The higher free acid level significantly reduces sludge generation, thereby eliminating the cost of properly disposing of the sludge, as well as any associated environmental hazards, and considerably reduces sensitivity to contaminants.

The present invention will be further appreciated in light of the following detailed description.

### DETAILED DESCRIPTION OF THE INVENTION

The conversion coating composition of the present invention is an aqueous based system that is added to a coating apparatus, either immersion or spray type coating apparatus, and diluted to an effective concentration. The composition will include a source of alkalinity, generally caustic soda; a source of manganese II ions; a source of nickel ions; a source of phosphate; and a source of zinc ions. Optionally, the composition can include an iron source as well as a source of fluoride.

The actual coating composition as applied to the substrate should have a concentration of phosphate anions of 2000 to 30,000 ppm and, preferably, 13,600 ppm. Hereinafter, the concentrations, particularly the preferred concentrations, can vary ±60%. The source of the phosphate ions can be a variety of different compositions. Phosphoric acid and its salts are preferred.

Zinc cations are also present in the coating solution, as applied to the substrate. The zinc ions can come from a variety of different sources, as long as the counter ion does not adversely affect the coating bath. Preferred sources of zinc ions include zinc phosphate and zinc oxide. The concentration of zinc ions in the coating solution can be from 500 to 3000 ppm, with about 1400 ppm preferred.

With respect to the manganese ions, these should be present as manganese II cations. Again, these can be derived from a variety of different manganese compositions as long as the counter ion does not adversely affect the coating composition. Preferred sources of manganese II include manganese phosphate and manganous oxide. The concentration of manganese ions in the coating solution should be 100 to 2000 ppm, with 620 ppm preferred.

The present invention will further include a source of nickel II ion. This can be derived from any suitable source of nickel, again, that does not have a counter ion that adversely affects the coating composition and, of course, assuming solubility in the coating composition. One preferred source of nickel is nickel nitrate hexahydrate. The nickel ion concentration in the coating solution should be 100 to 2000 ppm and, preferably, 900 ppm.

The present invention can further include a source of iron II. This can be, for example, ferrous sulfate or steel wool. The iron ion concentration should be 0 to 300 ppm, preferably 50 ppm.

Fluoride ions are unnecessary for practicing the present invention, except when coating aluminum substrates. However, they do not interfere with coating of other metals such as steel and galvanized surfaces. When coating aluminum or aluminized steel, there should be 500 to 3500 ppm fluoride ion, preferably 1550 ppm. This can be added as aluminum bifluoride.

The coating solution will also include nitrate and nitrite ions.

These work together in a redox reaction. Preferably, there are more nitrate ions than nitrite, but this is not critical. The ratio in the coating solution of nitrate to nitrite should be from 3 to 10, and preferably 3.8 to 5.

The concentration of nitrate ions should be 50 to 3000 ppm, and preferably 1900 ppm. Then nitrate ions are preferably supplied as counter ions to one or more of the metal ions or added as sodium nitrate.

The nitrite ions should be present in an amount of 50 to 1000 ppm, and preferably 430 ppm. The nitrite is added separately to the coating bath after all other components are added. An acceptable source of nitrite is sodium nitrite. There can be up to 4000 ppm sodium present.

The coating composition will further include a source of alkalinity effective to establish free acid range of 0.7-1.5, and preferably 1.0, for spray applications, and 3.5 to 5.5, preferably 4.5, for immersion applications. This can be accomplished by adding any source of alkalinity that will not adversely effect the coating solution. Sodium hydroxide is preferred.

With respect to free acid, this is a well-recognized term of art. If the composition has an initial pH value lower than 3.80±0.03, it has positive free acid points that are quantitatively defined as equal to the number of milliliters of 0.10N alkali required to titrate a 10 milliliter sample of the composition to a pH of 3.80. If the initial pH of a composition is higher than 3.80, it has a negative free acid value. The free acid value is defined as the negative number equal to the number of the milliliters of strong acid required to titrate a 10 milliliter sample of the composition to a pH of 3.80.

For spray application, the total acid value should be 15 to 45, preferably 20 to 35, and most preferably 22 to 32. The ratio of total acid to free acid should be 28 to 30.

For immersion application, the total acid value should be 15 to 45, preferably 20 to 35, and most preferably 20 to 35. The ratio of total acid to free acid should be 6 to 7.

The composition of the present invention can be formulated as a concentrated mix, using standard mixing procedures combining the source of zinc, source of phosphates, source of nickel, source of manganese, alkalinity source, and the deionized water, along with, optionally, the source of iron and the source of fluoride ions. This is been added to coating equipment either in an immersion system or a spray system. It can be used to coat cold rolled steel, electro galvanized steel, hot dip galvanized steel, electro galvaneal, galvanized steel, as well as aluminum and aluminum alloys.

The nitrite, which acts as an accelerator, is incorporated separately into the coating bath. The accelerator for use in the present invention is a nitrite accelerator such as sodium nitrite. The coating composition is applied to the selected substrate. This is a multiple step coating process that initially starts with a cleaning operation followed by a rinse wherein a surface activating composition, traditionally a Jernstedt slat is applied. This is a titanium-based activator, which is disclosed in U.S. Pat. Nos. 2,310,239 and 2,322,349, the disclosures of which are hereby incorporated herein by reference. The substrate is then passed through the zinc phosphate coating system of the present invention.

The zinc phosphate coating system is maintained at 120° to 160° F. With a spray system, the part is usually sprayed for about 60 seconds. With an immersion system, the substrate is immersed in the coating solution for 3 to 5 minutes. This is then rinsed, and passed on for further processing.

During the of the coating process, the operator maintains the free acid to total acid ratio by adjusting caustic concentration and/or coating concentration. If the free acid level becomes to high, caustic is added. If it becomes too low, additional coating composition is added. Further, the amount of nitrite activator is monitored and determined, and its concentration maintained by monitoring the gas point, which should be from about 0.9 to about 3.5.

One preferred phosphate conversion coating composition of the present invention is set forth below in TABLE 1. This does not include the nitrite activator that is added separately to the coating bath.

TABLE 1

| INGREDIENT | AMOUNT IN %, W/W |
|---|---|
| Zinc Oxide | 3.40% |
| Phosphoric Acid (75%) | 37.50% |
| Nickel Nitrate, hexahydrate | 8.90% |
| Manganous Oxide | 1.60% |
| Ferrous Sulfate | 0.05% |
| Deionized Water | 46.45% |
| Caustic Soda, 50% | 2.10% |

Appearance: clear pale green liquid
Density @ 78° F.: 1.3348 kg/l
pH as supplied: 2.2

The solution set forth in TABLE 1 was added to a coating bath and diluted, and nitrite was added. This was used to coat metal substrates according to the following example.

All panels for test evaluation were from ACT Laboratories, Inc., Hillsdale, Mich., including Cold Rolled Steel, Zinc Hot Dip Galvanized Steel (HOG70G70U), Zinc Electro Galvanized Steel (60G60E), Zinc/Iron Hot Dip Galvanized Steel (E1A 30A45) and Aluminum (ALM6061T6).

Bath Solution Preparation

A phosphatizing bath solution in accordance with the present invention shown in Table 1 was prepared by diluting a concentrate and neutralizing the bath by caustic soda to the desired free acid levels. Free and total acid level measurement was determined as set forth in Example 2.

The phosphatizing bath solution in Table 2 was used to phosphatize cold rolled steel, zinc hot dip galvanized steel (H0G70G70U), zinc electro galvanized steel (60G60E), zinc/iron hot dip galvanized steel (E1A30A45). Furthermore, the coating compositions shown in Table 3 (which includes fluoride ion) was used to phosphatize aluminum coated steel and aluminum.

TABLE 2
Working Solution (A)

| Ion Identification | Ion Concentration (g/L) |
|---|---|
| Fe²⁺ | 0.005 |
| Mn²⁺ | 0.62 |
| Na⁺ | 1.84 |
| Ni²⁺ | 0.9 |
| NO₂²⁻ | 0.43 |
| NO₃⁻ | 1.9 |
| PO₄³⁻ | 13.64 |
| SO₄²⁻ | 0.009 |
| Zn²⁺ | 1.38 |

TABLE 3
Working Solution (B)

| Ion Identification | Ion Concentration (g/L) |
|---|---|
| F⁻ | 1.55 |
| Fe²⁺ | 0.005 |
| Mn²⁺ | 0.62 |
| Na⁺ | 2.84 |
| Ni²⁺ | 0.9 |
| NO₂²⁻ | 0.43 |
| NO₃⁻ | 1.9 |
| PO₄³⁻ | 13.64 |
| SO₄²⁻ | 0.009 |
| Zn²⁺ | 1.38 |

Concentration Measurement Methods for Phosphate Bath Solutions

FA and TA determinations were conducted in a conventional manner. For FA, a 25-50 mL buret was filled and zeroed with 0.1 N NaOH. A 100-mL sample of bath solution of the present invention was poured into a 200 mL beaker, a magnetic stirrer and stir the solution, and titrated with 0.1 N NaOH. Wash the electrode of a pH meter with distilled water and place it into the sample solution. While stirring, titrate the sample with 0.1 N NaOH slowly to the pH value of 3.8. The number of milliliters of 0.1 N NaOH consumed was divided by 10, and the result presented here is the FA value of the both solution.

For TA, a 25-50 mL buret was filled and zeroed with 0.1 N NaOH. A 100 mL sample of bath solution of the present invention was poured into a 200 mL beaker, a magnetic stirrer and stir the solution, and titrated with 0.1 N NaOH. Wash the electrode of a pH meter with distilled water and place it into the sample solution. While stirring, titrate the sample with 0.1 N NaOH slowly to the pH value of 8.3. The number of milliliters of 0.1 N NaOH consumed was divided by 10, and the result presented here is the TA value of the both solution.

In regard to determinations of FA and TA, both are measurable with one sample solution, that is, record numbers of milliliters of 0.1 N NaOH consumed at pH 3.8 and 8.3, which are divided by 10 separately. The results reported are FA and TA as points, respectively.

Phosphatizing Ferrous and Zinc-Coating Metals

This example demonstrates the efficiency and effectiveness of the working solution (A) to phosphatize ferrous and zinc-coated metals at the much lower nitrate level, higher FA level, and without the assistance of fluorine components, all of which reduce the sludge level and provide a longer bath life. Metals were cleaned in a conventional alkaline cleaner, rinsed and activated with Jernstedt slat solution. Metals were treated with solution (A) as set forth in TABLE 1 at FA 3.5-5.5, the most preferable at FA 4.5, at 125-185° F., the most preferable at 130-160° F., for 3-7 minutes in an immersion bath (most preferably for 5 minutes). Metals were then rinsed. The average crystal sizes and coating weight of the resultant coatings were measured, as illustrated in TABLE 4.

Phosphatizing Aluminum and its Alloys

This example demonstrates the efficiency and effectiveness of the working solution (B) to phosphatize aluminum and its alloys at the much lower nitrite level, higher FA level, and with the assistance of lower fluorine components, all of which reduce the sludge level and provide a longer bath life. Aluminum and its alloys were cleaned in a conventional mild cleaner or stronger either alkaline or acidic cleaner followed by desmutting, rinsing and activation with a Jernstedt slat solution. Aluminum and its alloys were treated with the inventive tank solution (B) as set forth in TABLE 2 at FA 3.5-5.5, the most preferable at FA 4.5, at 125-185° F., the most preferable at 150-165° F., for 3-7 minutes in immersion bath, the most preferable for 5 minutes. Metals were then rinsed. The average crystal sizes and coating weight of the resultant coatings were measured, as illustrated in TABLE 4.

TABLE 4

| | Average Crystal | Average |
|---|---|---|
| | Size | Coating Weight |
| Type of Metal | μm | mg/ft² |
| Cold Rolled Steel | 4 | 230 |
| Zinc Hot Dip Galvanized Steel | 6 | 270 |
| Zinc Electro Galvanized Steel | 5 | 270 |
| Zinc/Iron Hot Dip Galvanized Steel | 6 | 270 |
| Aluminum | 5 | 250 |

This process provides a very fine crystalline phosphate coating which is suitable for painting. Because of the high free acid level and free acid to total acid ratio, sludge is minimized. Further, the present invention operates at a relatively low temperature.

This has been a description of the present invention along with the preferred method of practicing the present invention. However, the invention itself should only be defined by the appended claims,

Wherein We claim:

1. A manganese modified low zinc phosphate coating solution:
comprising water;
manganese ion;
nickel ion;
phosphate ion;
zinc ion;
nitrate ion; and
nitrite activator
wherein said solution has a free acid point greater than 0.7.

2. The solution claimed in claim 1 wherein said free acid point is from 0.7 to 5.5 and the total acid value is from 15 to 35.

3. The solution claimed in claim 1 wherein said free acid value is from 0.7 to 1.5 and the total acid value is from 15 to 45.

4. The solution claimed in claim 1 wherein said free acid point is from 3.5 to 5.5 and the total acid value is from 14 to 45.

5. The solution claimed in claim 1 having from about 50-1000 ppm dissolved nitrite ions and 50-3000 ppm dissolved nitrate ions and where in the ratio of nitrate to nitrite is from 3 to 10.

6. The solution claimed in claim 5 comprising 1000-2000 ppm manganese ion; 1000-2000 ppm dissolved nickel ion; 2000-30,000 dissolved phosphate ion; and 500-3000 dissolved zinc ion.

7. The solution claimed in claim 6 further including dissolved ferrous ions; 0-4000 ppm dissolved sodium ions; and 0-100 ppm dissolved sulfate ions.

8. The composition claimed in claim 6 further comprising 500-3500 ppm dissolved fluoride ion.

9. The solution claimed in claim 6 comprising about 430 ppm (±60%) dissolved nitrite ions; 1900 ppm (±60%) nitrate ions; 620 ppm (±60%) manganese ions; 900 ppm (±60%) nickel ions; 13,600 ppm (±60%) phosphate ions; and 1400 ppm (±60%) zinc ions.

10. The solution claimed in claim 9 further including 50 ppm (±60%) ferrous ions; 1840 ppm (±60%) sodium ions; and 10 ppm (±60%) sulfate ions.

11. The solution claimed in claim 10 further including 1550 ppm (±60%) fluoride ions.

12. A method of coating a metallic substrate comprising applying to a surface of said substrate the solution of claim 1.

13. The method of claim 12 comprising spraying onto said substrate the solution of claim 1 wherein said solution has a free acid point of 0.7-1.5.

14. The method of claim 12 wherein said substrate is immersed in a bath of said solution and wherein said solution has a free acid level of 3.5-5.5.

15. A method of coating an aluminum substrate comprising applying to said substrate the composition claimed in claim 8.

16. The method claim claimed in claim 15 wherein said aluminum substrate is selected from the group consisting of aluminum and aluminized steel.

17. A method of coating an aluminum substrate comprising applying to said substrate the solution claimed in claim 11.

18. The solution claimed in claim 1 wherein said solution includes 50-1000 ppm dissolved nitrite ions and 50-3000 ppm dissolved nitrate ions and wherein the total concentration of nitrite and nitrate ions is less than 4000 ppm and wherein the nitrate to nitrite range is from 3.8-5.
